(19) United States
(12) Patent Application Publication
(10) Pub. No.: US 2024/0421907 A1
(43) Pub. Date: Dec. 19, 2024

(54) OPTICAL REPEATER SYSTEM, OPTICAL REPEATER DEVICE, MASTER UNIT, AND SYNCHRONIZATION CONTROL METHOD

(71) Applicants: KABUSHIKI KAISHA TOSHIBA, Tokyo (JP); Toshiba Infrastructure Systems & Solutions Corporation, Kawasaki-shi (JP)

(72) Inventors: Taiki MURAKAMI, Fuchu Tokyo (JP); Kyosuke Dobashi, Higashimurayama Tokyo (JP); Hiroaki Fukui, Fuchu Tokyo (JP)

(73) Assignees: KABUSHIKI KAISHA TOSHIBA, Tokyo (JP); Toshiba Infrastructure Systems & Solutions Corporation, Kawasaki-shi (JP)

(21) Appl. No.: 18/818,931

(22) Filed: Aug. 29, 2024

Related U.S. Application Data
(63) Continuation of application No. PCT/JP2023/004551, filed on Feb. 10, 2023.

(30) Foreign Application Priority Data
Mar. 11, 2022 (JP) 2022-038471

(51) Int. Cl. H04B 10/294; H04B 10/2575

(52) U.S. Cl. CPC H04B 10/294; H04B 10/25759

(57) ABSTRACT

The optical repeater system of an embodiment includes master units connectable to a base station to which a carrier band to be subjected to carrier aggregation is assigned and a remote unit capable of transmitting and receiving an uplink/downlink signal of the carrier band. The master unit includes memory, timing detector, information sharer, determinator and synchronization controller. The memory stores a weight assigned to the each master unit. The timing detector detects a UL/DL switching timing for each carrier band of a subordinate base station. The information sharer communicates with another master unit and shares information including at least the weight and a latest UL/DL switching timing among the detected UL/DL switching timings with the another master unit. The determinator determines the own UL/DL switching timing based on the shared information. The synchronization controller sets the own UL/DL switching timing to the determined UL/DL switching timing.

### CROSS REFERENCE TO RELATED APPLICATION(S)

This application is a Continuation Application of PCT Application No. PCT/JP2023/004551, filed Feb. 10, 2023 and based upon and claiming the benefit of priority from prior Japanese Patent Applications No. 2022-038471, filed Mar. 11, 2022, the entire contents of all of which are incorporated herein by reference.

### FIELD

Embodiments of the present invention relate to an optical repeater system, an optical repeater device, a master unit, and a synchronization control method.

### BACKGROUND

A communication area of the fifth generation mobile communication system (5G) is gradually expanding. Optical repeater devices play a role in expanding the area. This device, also known as a distributed antenna system (DAS), includes a master unit (master station) connected to a base station and a remote unit (remote station) connected to the master unit via an optical fiber.

Upon introduction of the 5G, infrastructure sharing is applied. The infrastructure sharing is an idea that a communication infrastructure is commonly used by a plurality of service providers mainly for cost advantage. Also in the DAS, it has been studied to accommodate a plurality of base stations of different owners in one master unit. If this technique is applied to the local 5G, the same master unit can be shared by a communication service provider and a licensed person. This type of master unit is also referred to as a service provider sharing device.

### BRIEF DESCRIPTION OF THE DRAWINGS

FIG. 1 is a block diagram illustrating an example of an optical repeater device according to an embodiment.

FIG. 2 is a block diagram illustrating an example of an optical repeater system according to an embodiment.

FIG. 3 is a diagram illustrating an example of an unsynchronized state in the optical repeater system.

FIG. 4 is a diagram illustrating an example of a synchronized state in the optical repeater system.

FIG. 5 is a diagram for describing setting of a CA candidate device group.

FIG. 6 is a diagram illustrating an example of a timing chart in Case 0.

FIG. 7 is a diagram illustrating an example of a timing chart in Case 1.

FIG. 8 is a table illustrating a state illustrated in FIG. 7.

FIG. 9 is a diagram illustrating an example of a timing chart in Case 2.

FIG. 10 is a table illustrating a state illustrated in FIG. 9.

FIG. 11 is a functional block diagram illustrating an example of a master station 100 and a remote station 200.

FIG. 12 is a functional block diagram illustrating an example of a processor 140 and a memory 150.

FIG. 13 is a flowchart illustrating an example of a processing procedure of the master station 100 according to the embodiment.

FIG. 14 is a flowchart illustrating an example of a processing procedure in step 5 in FIG. 13.

FIG. 15 is a diagram illustrating an example of information registered in a management table 150d.

FIG. 16 is a diagram illustrating another example of the management table 150d.

FIG. 17 is a diagram illustrating another example of the management table 150d.

FIG. 18 is a diagram illustrating another example of the management table 150d.

FIG. 19 is a diagram illustrating another example of the management table 150d.

### DETAILED DESCRIPTION

The optical repeater system of an embodiment includes a plurality of master units connectable to a base station to which a carrier band to be subjected to carrier aggregation is assigned and a remote unit including an antenna capable of transmitting and receiving an uplink/downlink (UL/DL) signal of the carrier band. Each of the master units includes a memory, a timing detector, an information sharer, a determinator and a synchronization controller. The memory stores a weight assigned to the each master unit in advance. The timing detector detects a UL/DL switching timing for each carrier band of subordinate base station. The information sharer communicates with another master unit and shares information including at least the weight and a latest UL/DL switching timing among the detected UL/DL switching timings with the another master unit. The determinator autonomously determines the own UL/DL switching timing based on the shared information. The synchronization controller sets the own UL/DL switching timing to the determined UL/DL switching timing.

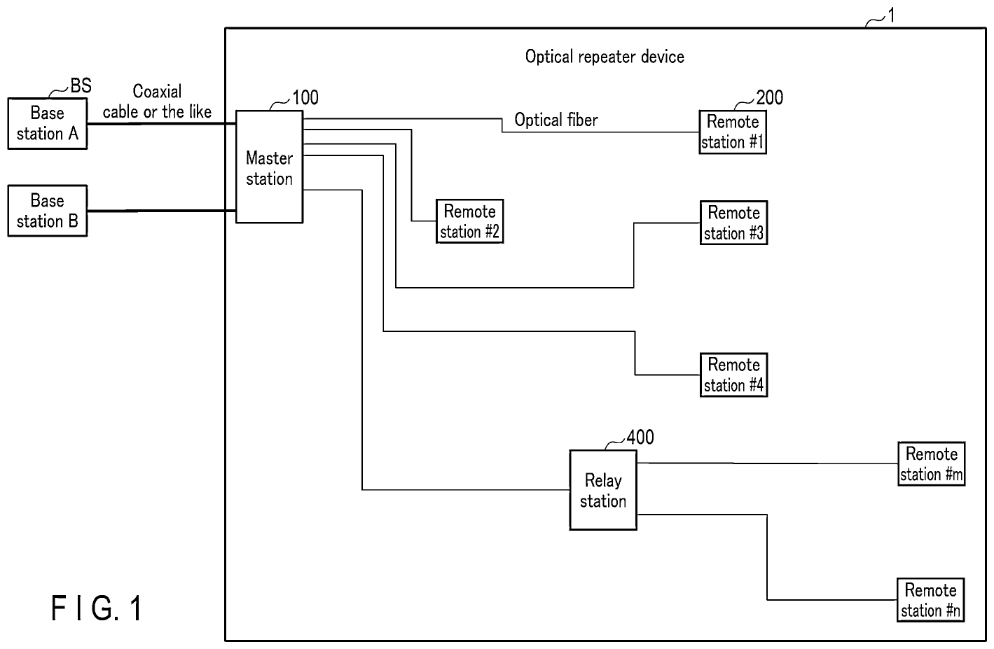

FIG. 1 is a block diagram illustrating an example of an optical repeater device according to an embodiment. The optical repeater device includes a station (master unit (MU)) 100 and a plurality of remote stations (remote units (RUs)) 200 (#1 to #n) connected to the master station 100 via optical fibers. This form of system is also referred to as a distributed antenna system (DAS). A relay station 400 may be provided between the master station 100 and the remote station 200.

One or more base stations BS are accommodated in the master station 100 via coaxial cables or the like. In the connection by the coaxial cables, for example, four systems of radio signals can be transmitted in a 100 MHz band ×4 (4×4 MIMO) for each base station BS.

A carrier band is assigned to each base station BS. In the embodiment, carrier aggregation in which a plurality of carrier bands is collected to increase a band will be described. That is, each carrier band is a target of the carrier aggregation. Note that, in an air section deployed from the remote station 200, synchronization of UL/DL switching timing of each carrier band needs to fall within 3 μs.

The base station BS exchanges a UL signal and a DL signal with the remote station 200 via the master station 100. A mobile terminal (user equipment (UE)) (not illustrated) is connected to any one of the remote stations (#1 to #n) via a radio channel in a radio zone in which the remote station 200 is deployed.

The remote station 200 includes an antenna capable of transmitting and receiving an uplink/downlink (UL/DL) signal of the carrier band assigned to the base station BS.

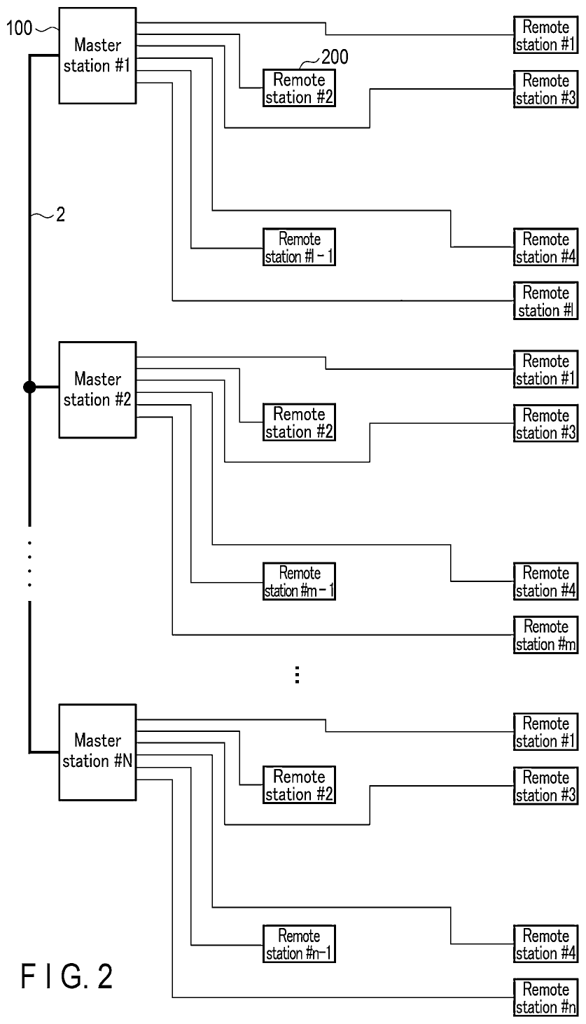

FIG. 2 is a block diagram illustrating an example of an optical repeater system according to the embodiment. The optical repeater system includes a plurality of the optical repeater devices. The master station 100 of each optical repeater device accommodates a plurality of the remote stations 200. For example, 1 remote stations are connected to a master station #1, m remote stations are connected to a master station #2, and n remote stations are connected to a master station #N. In this optical repeater system, the master stations 100 of the respective optical repeater devices are communicably connected to one another. In FIG. 2, the master stations #1, #2, . . . , and #N are connected to one another via a wired line 2. The master stations #1, #2, . . . , and #N can exchange various types of information with one another via the wired line 2.

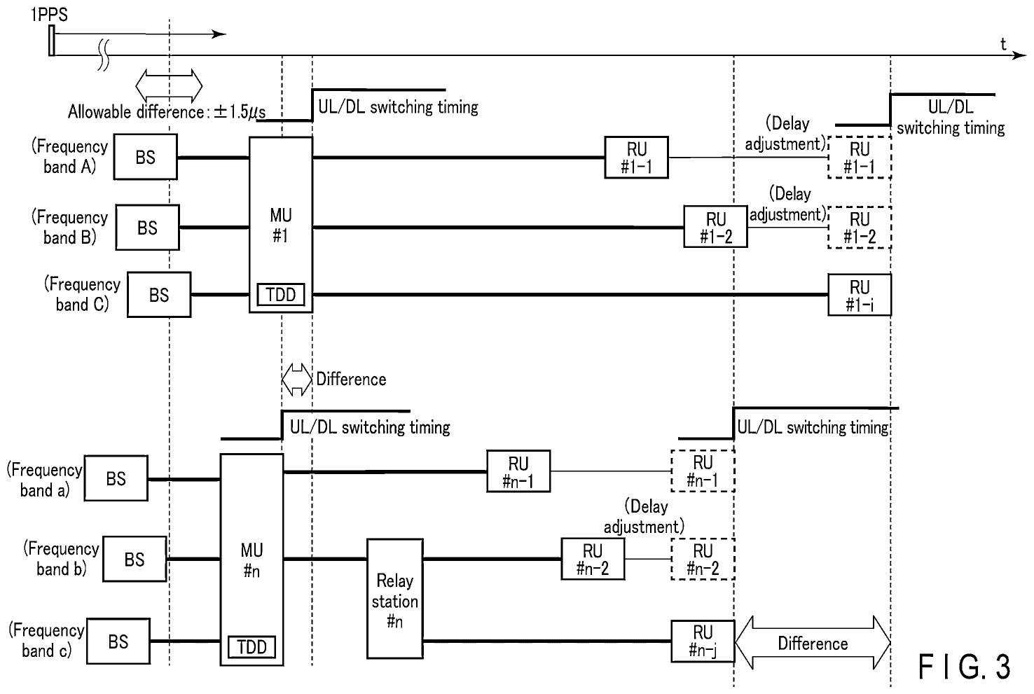

FIG. 3 is a diagram illustrating an example of an unsynchronized state in the optical repeater system. In FIG. 3, the horizontal axis represents passage of time. The UL/DL switching timings of the base stations BS (frequency bands A, B, and C) accommodated in the master station #1 are shifted within a range of an allowable difference ±1.5 μs (microseconds) regardless of whether the service providers are the same or different. Similarly, the UL/DL switching timings of the base stations BS (frequency bands a, b, and c) accommodated in the master station #n are shifted within the range of the allowable difference ±1.5 μs (microseconds) regardless of the difference. This shift is mainly caused by a difference in a length of the coaxial cable, and is allowable as long as the shift is within the range of ±1.5 μs.

Further, the UL/DL switching timings are often shifted with some difference even between the master stations. Moreover, the timing for each remote station is shifted due to a difference in a length of the optical fiber. In operation of the DAS, the UL/DL switching timing of a radio wave radiated from the remote station needs to be kept within 3 μs prescribed by 3GPP (registered trademark).

Therefore, each master station includes a timing detection unit, and individually detects the UL/DL switching timing of the subordinate base station BS and exchanges and shares timing information with other master stations. In addition, each master station synchronizes its own UL/DL switching timing with the latest timing. Further, each master station individually detects a delay amount of the subordinate remote station 200, and exchanges and shares the timing information with other master stations. In addition, each master station synchronizes the UL/DL switching timing of the subordinate remote station 200 with the latest timing.

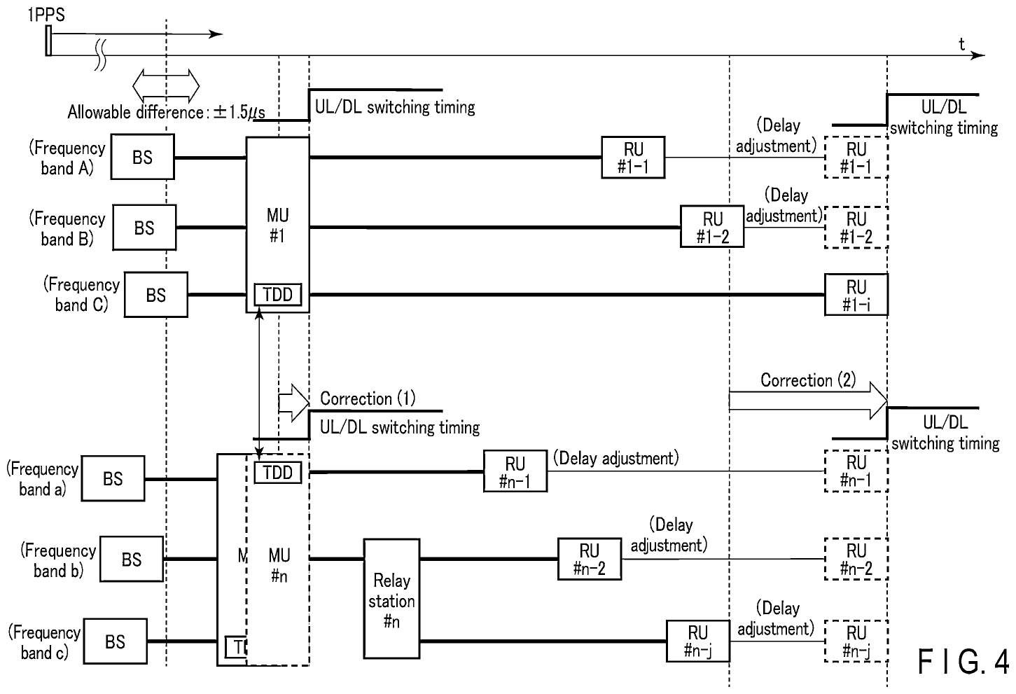

FIG. 4 is a diagram illustrating an example of a synchronized state in the optical repeater system. The master stations notify each other of the UL/DL switching timings of the subordinate base stations and the delay amounts of the remote stations, and correct the timings to the latest timing, t a state in which synchronization is established at the exit of the remote stations 200 as illustrated in FIG. 4.

By the way, to synchronize the UL/DL switching timings between the plurality of optical repeater devices, a majority decision method is simply adopted. A concept of a CA candidate device group relates to the majority decision method. The CA candidate device group is a group including a plurality of master stations that are candidates for executing carrier aggregation (CA). From another point of view, the CA candidate device group is a group including the master stations having the UL/DL switching timing that falls within 3 μs. From still another point of view, the CA candidate device group is a set of master stations in which the UL/DL switching timing for satisfying a CA requirement specification of a 3GPP standard falls within a valid correction range. That is, CA can be executed between any two or all of the master stations included in the CA candidate device group.

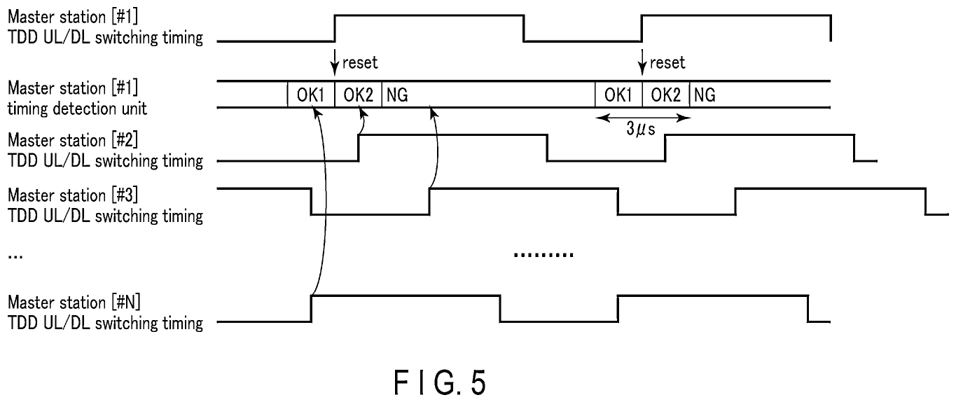

FIG. 5 is a diagram for describing setting of the CA candidate device group. In FIG. 5, the master station [#1] performs comparison with the UL/DL switching timings of the other master stations [#2] to [#N] based on the UL/DL switching timing of the local station detected in the own station. Here, the comparison is performed based on a rising edge (reset timing).

In the case of FIG. 5, the UL/DL switching timings of the master stations [#2] and [#N] are within an OK area (the range of ±1.5 μs) when viewed from the master station [#1], but the UL/DL switching timing of the master station [#3] is in an NG area outside the OK area. In this case, the CA candidate device group viewed from the master station [#1] includes ([#1], [#2], and [#N]). Since timing detection criteria are different for each master station, the CA candidate device group is generally different for each master station.

In the embodiment, it is assumed that CA is executed between the master stations included in the CA candidate device group in which the number of master stations falling within areas (“OK1” and “OK2”) within 3 μs prescribed by 3GPP as a correction valid range is the majority and the maximum (principle of majority decision). Here, it is assumed that the UL/DL switching timing of a carrier radiated from the remote station is matched with the latest timing among the master stations included in the CA candidate device group. On the other hand, it is assumed that the master stations belonging to the CA candidate device group in which the number of master stations is not the majority are assumed to be stopped.

Next, a specific example relating to execution of CA will be described. In the following description, the number N of master stations is set to N=4 and the four master stations [#1] to [#4] are assumed to be involved, and three cases having different UL/DL switching timings are adopted.

### <Case 0>

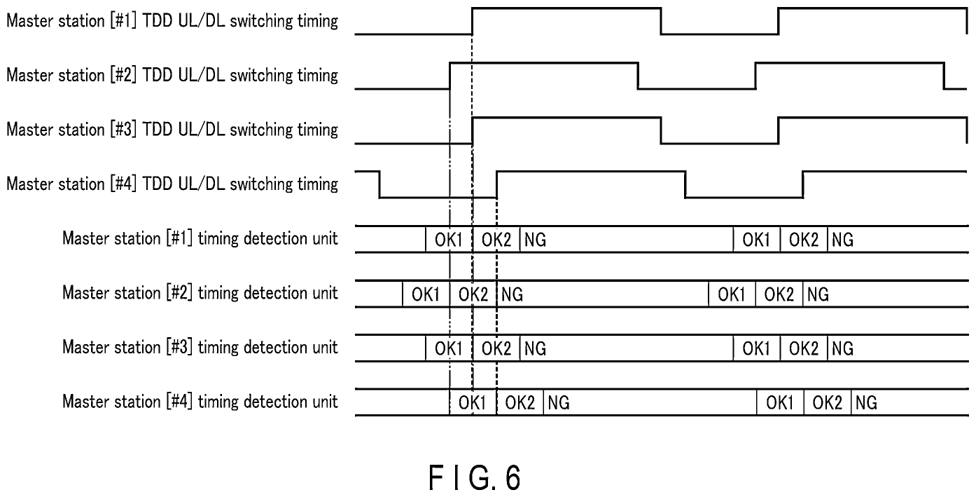

FIG. 6 is a diagram illustrating an example of a timing chart in Case 0. In FIG. 6, the UL/DL switching timings of all the master stations [#1] to [#4] fall within the correction valid range (OK1 or OK2) of all the master stations. Since the UL/DL switching timing of the master station [#4] is the latest, the other master stations [#1] to [#3] match their own UL/DL switching timings with the latest UL/DL switching timing. Then, a delay time of the subordinate remote station is set to the latest delay time among shared delay times.

Case 0 is a case of having no problem in the majority decision method. However, there are cases that cannot be solved by the majority decision method. Next, the cases that cannot be solved by the majority decision method will be described as Case 1 and Case 2.

### <Case 1>

Case 1 is a case where the radio wave is transmitted from the remote station even though the UL/DL switching timing is mismatched.

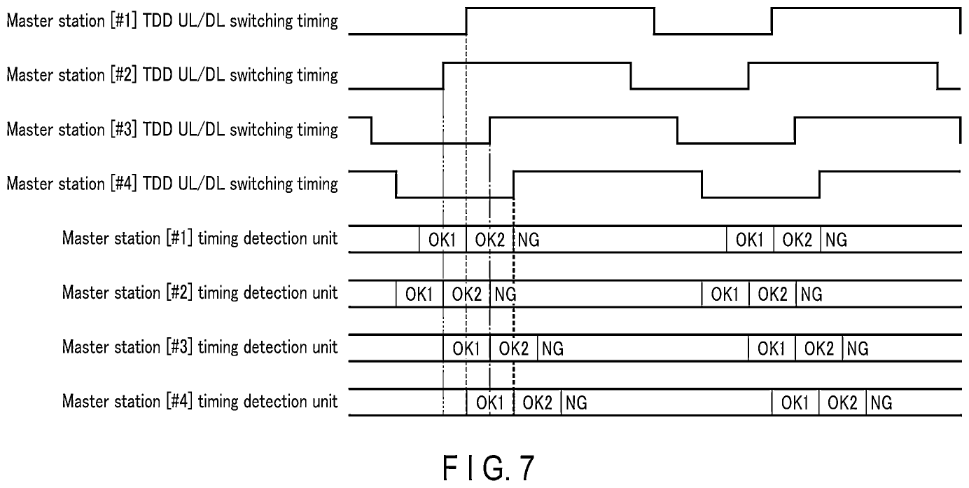

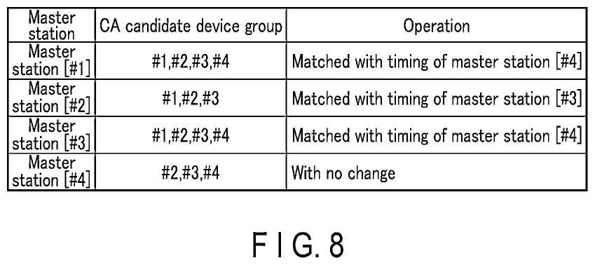

FIG. 7 is a diagram illustrating an example of a timing chart in Case 1. In FIG. 7, for the master station [#1] and the master station [#3], the UL/DL switching timings of all the devices fall within the correction valid range (OK1 or OK2). On the other hand, for the master station [#2], the UL/DL switching timing of the master station [#4] is in the NG area, and for the master station [#4], the UL/DL switching timing of the master station [#2] is in the NG area. This state is illustrated in the table in FIG. 8.

FIG. 8 is the table illustrating the state illustrated in FIG. 7. According to FIG. 8, for each master station, the number of devices in the CA candidate device group to which the each master station belongs occupies the majority, there is no device (master station) to be stopped according to the majority decision method. However, under the rule that the UL/DL switching timing is matched with the latest UL/DL switching timing in the CA candidate device group, the UL/DL switching timings of the master station [#1], the master station [#3], and the master station [#4] are matched (with that of the master station [#4]), whereas the UL/DL switching timing of the master station [#2] is matched with the UL/DL switching timing of the master station [#2]. As a result, the UL/DL switching timings of the master station [#1], the master station [#3], and the master station [#4] are mismatched with the UL/DL switching timing of the master station [#2], and there is a risk of an interference if the radio wave is transmitted without any change.

### <Case 2>

Case 2 is a case where all the master stations are stopped.

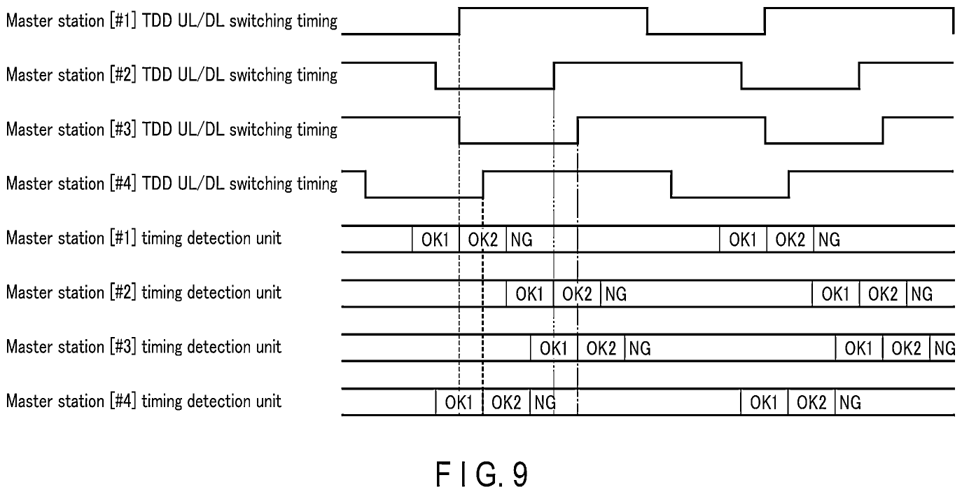

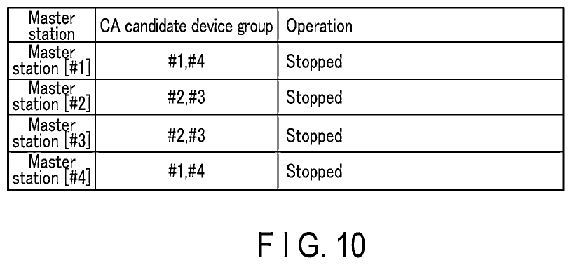

FIG. 9 is a diagram illustrating an example of a timing chart in Case 2. In FIG. 9, for the master station [#1], only the UL/DL switching timing of the master station [#4] falls within the correction valid range (OK1 or OK2). For the master station [#4], only the UL/DL switching timing of the master station [#1] falls within the correction valid range (OK1 or OK2). Meanwhile, for the master station [#2], only the UL/DL switching timing of the master station [#3] falls within the correction valid range (OK1 or OK2), and for the master station [#3], only the UL/DL switching timing of the master station [#2] falls within the correction valid range (OK1 or OK2). This state is illustrated in the table in FIG. 10.

FIG. 10 is the table illustrating the state illustrated in FIG. 9. According to FIG. 10, for each of all the master stations, the number of devices in the CA candidate device group to which the each master station belongs is not the majority. Therefore, under the majority decision method, all the master stations are stopped. That happens in spite of room for others to match the UL/DL switching timing with that of the master station #3, for example.

As described above, there are cases that cannot be solved only by the majority decision method. Next, a technique capable of solving such a problem will be described.

### (Configuration)

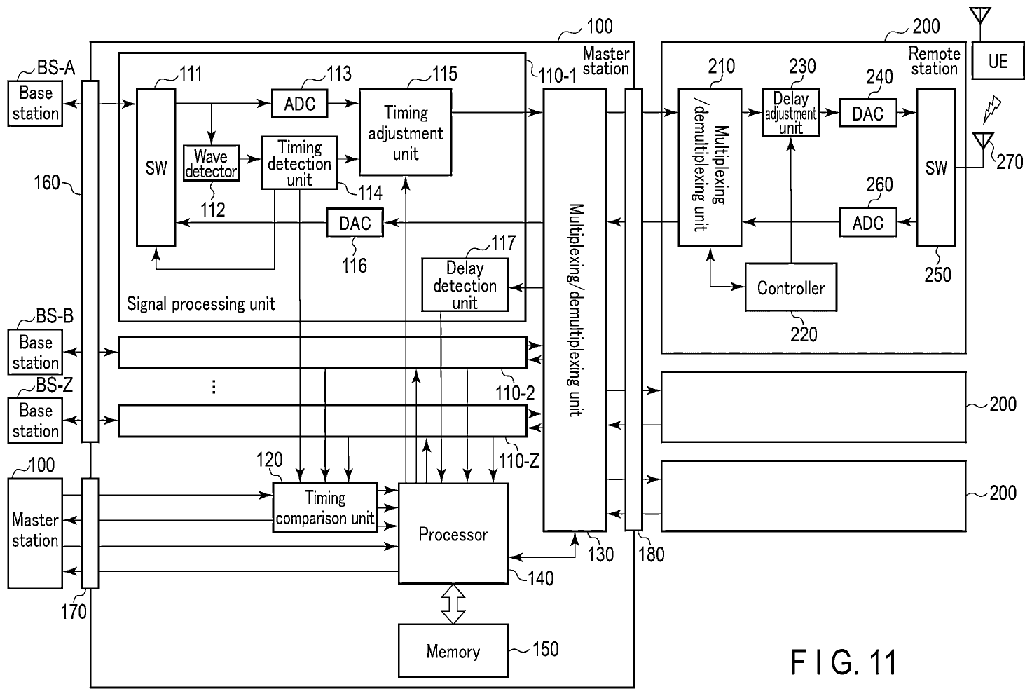

FIG. 11 is a functional block diagram illustrating an example of the master station 100 and the remote station 200.

In FIG. 11, the master station 100 includes signal processing units 110-1 to 110-Z, a timing comparison unit 120, a multiplexing/demultiplexing unit 130, a processor 140, a memory 150, a base station connection unit 160, a master station connection unit 170, and a remote station connection unit 180. That is, the master station 100 is a computer including a processor and a memory.

The base station connection unit 160 is an interface for accommodating the plurality of base stations BS, and can be connected to the base stations BS-A, BS-B, . . . , and BS-Z via a coaxial cable or the like in FIG. 11.

The master station connection unit 170 is an interface for communicating with another master station 100, and can be connected to another master station 100 by a local area network (LAN), a serial cable, or the like.

The remote station connection unit 180 is connected to the plurality of subordinate remote stations 200 via optical fibers. That is, the remote station 200 is accommodated in the master station 100 via the optical fiber.

The signal processing units 110-1 to 110-Z are associated with the corresponding base stations BS-A, BS-B, . . . , and BS-Z, respectively, and exchange UL/DL signals with the base stations BS-A, BS-B, . . . , and BS-Z via the base station connection unit 160. That is, the radio signal transmitted and received to and from the mobile terminal UE is exchanged in both UL and DL directions for each of the base stations BS-A, BS-B, . . . , and BS-Z via the signal processing units 110-1 to 110-z.

The timing comparison unit 120 compares the UL/DL switching timing for each carrier band detected in each of the signal processing units 110-1 to 110-Z, and generates a delay adjustment amount. A comparison result and the delay adjustment amount are passed to the signal processing unit 110-1 to 110-Z and the processor 140.

The multiplexing/demultiplexing unit 130 converts the DL signal from each of the signal processing units 110-1 to 110-Z into an optical signal, then performs wavelength multiplexing, and transmits the optical signal from the remote station connection unit 180 to each remote station 200 via the optical fiber.

Further, the multiplexing/demultiplexing unit 130 receives the optical signal from each of the remote stations 200 to 200 via the optical fiber, demultiplexes the optical signal for each carrier band in units of wavelength, converts the optical signal into an electrical signal, and extracts a digital signal. This digital signal is transmitted to one of the signal processing units 110-1 to 110-Z, the one corresponding to the carrier band.

The processor 140 acquires the comparison result of the UL/DL switching timing for each carrier band and a transmission delay time for each remote station 200 detected by each of the signal processing units 110-1 to 110-Z.

The memory 150 stores various programs, setting data, and the like, and a weight assigned in advance to each master station 100.

Each of the signal processing units 110-1 to 110-Z includes a transmission/reception changeover switch (SW) 111, a wave detector 112, an A/D converter (ADC) 113, a timing detection unit 114, a timing adjustment unit 115, a D/A converter (DAC) 116, and a delay detection unit 117.

The transmission/reception changeover switch 111 switches the uplink/downlink switching timing with respect to the opposing base station BS in synchronization with the UL/DL switching timing provided from the timing detection unit 114. As a result, communication based on time division duplex (TDD) is implemented.

A carrier band signal from the opposing base station BS is transmitted to the A/D converter 113 and the wave detector 112. The A/D converter 113 converts the carrier band signal into the digital signal and outputs the digital signal to the timing adjustment unit 115. The wave detector 112 detects a wave of the carrier band signal, and transmits a detected waveform to the timing detection unit 114.

The timing detection unit 114 detects the UL/DL switching timing for each carrier band of the base station BS based on the detected waveform. The timing detection unit 114 generates a timing signal (pulse signal) based on the detected UL/DL switching timing, and outputs the timing signal to transmission/reception changeover switch 111, the timing adjustment unit 115, and the timing comparison unit 120.

The timing adjustment unit 115 delays an output of the A/D converter (ADC) 113 by providing a delay according to the delay adjustment amount to adjust the switching timing. As a result, first correction processing ((1) in FIG. 4) for synchronizing the master stations 100 is implemented.

The digital signal from the multiplexing/demultiplexing unit 130 is input to a D/A converter (DAC) 116 and the delay detection unit 117. The D/A converter 116 converts the digital signal into an analog signal, up-converts the analog signal into the carrier band, and reads an uplink signal. This uplink signal is transmitted to the base station BS via the transmission/reception changeover switch 111 and the coaxial cable.

The delay detection unit 117 monitors the digital signal from the multiplexing/demultiplexing unit 130, exchanges a control signal with the remote station 200, for example, and detects a transmission delay amount between the master station 100 and the remote station 200. The detected transmission delay amount is passed to the processor 140.

Meanwhile, the remote station 200 includes an antenna 270, a multiplexing/demultiplexing unit 210, a controller 220, a delay adjustment unit 230, a D/A converter (DAC) 240, a transmission/reception changeover switch (SW) 250, and an A/D converter (ADC) 260.

The multiplexing/demultiplexing unit 210 demultiplexes the optical signal from the master station 100 into wavelengths, converts the optical signal into an electrical signal, and extracts a digital downlink signal. The controller 220 detects a signal addressed to the remote station 200 from the downlink signal, detects the delay adjustment amount included in the signal and transmitted from the processor 140 of the master station 100, and outputs the delay adjustment amount to the delay adjustment unit 230.

The delay adjustment unit 230 delays a transmission timing of the downlink signal based on the delay adjustment amount from the controller 220. As a result, second correction processing ((2) in FIG. 4) for implementing synchronization including the master station 100 and the remote station 200 is implemented. The delay-controlled downlink signal is output to the D/A converter 240. The D/A converter 240 converts the downlink signal into an analog signal and up-converts the analog signal into a band of an assigned channel. The downlink signal of the radio band is radiated to the air section via the transmission/reception changeover switch 250 and the antenna 270, and is received by the mobile terminal UE.

The uplink signal from the mobile terminal UE is transmitted from the antenna 270 of the remote station 200 to the A/D converter 260 via the transmission/reception changeover switch 250. The A/D converter 260 down-converts the uplink signal received from the mobile terminal UE into a baseband and then digitally converts the uplink signal, and outputs the digital signal to the multiplexing/demultiplexing unit 210. The multiplexing/demultiplexing unit 210 converts the digital signal into an optical signal, then multiplexes the optical signal, and transmits the optical signal to the master station 100 via the optical fiber.

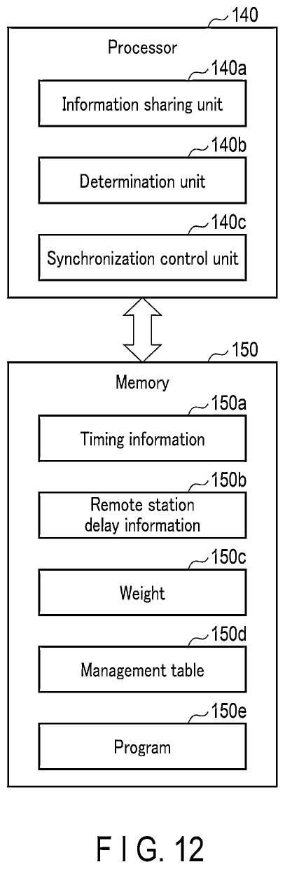

FIG. 12 is a functional block diagram illustrating an example of the processor 140 and the memory 150. The processor 140 includes an information sharing unit 140a, a determination unit 140b, and a synchronization control unit 140c as processing functions according to the embodiment.

The information sharing unit 140a communicates with the other master stations 100 and shares the weight assigned to the local station in advance and the latest UL/DL switching timing among the UL/DL switching timings detected by the timing detection unit 114. The master stations 100 share at least these pieces of information, but it is of course possible to share more various pieces of information.

The determination unit 140b autonomously determines its own UL/DL switching timing based on the shared weights and UL/DL switching timings, and calculates the delay adjustment amount.

The synchronization control unit 140c sets the delay adjustment amount in the timing adjustment unit 115 so as to set its own UL/DL switching timing to the UL/DL switching timing determined by the determination unit 140b.

The memory 150 is a nonvolatile memory such as a flash memory, and stores timing information 150a, remote station delay information 150b, a weight 150c, a management table 150d, and a program 150e.

The timing information 150a includes the UL/DL switching timing detected by the timing detection unit 114, the UL/DL switching timings shared with the other master stations 100, and the like.

The remote station delay information 150b includes the delay amount of the remote station 200 detected by the delay detection unit 117, the delay amount of the remote station 200 shared with another master station 100, and the like.

The weight 150c is set and stored in advance in association with the number of connected subordinate remote stations 200 of the local station and the carrier band assigned to the subordinate base station BS.

The management table 150d is generated and stored in each master station 100 based on the information shared with the other master stations 100 and the UL/DL switching timing, the delay amount, and the like detected by the local station.

The program 150e includes a command for causing the processor 140 to function as the information sharing unit 140a, the determination unit 140b, and the synchronization control unit 140c.

### (Operation)

Next, an operation in the above configuration will be described.

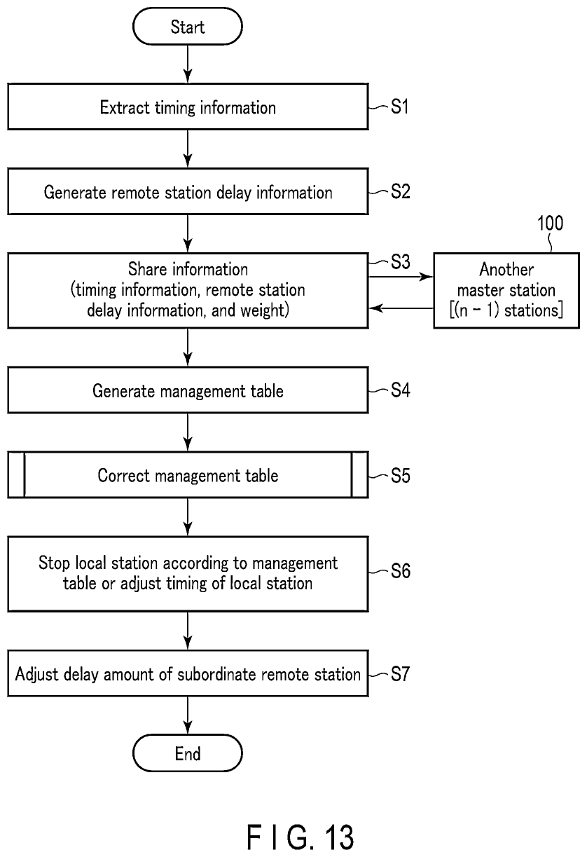

FIG. 13 is a flowchart illustrating an example of a processing procedure of the master station 100 according to the embodiment. In FIG. 1, the master station 100 detects the UL/DL switching timing of the carrier band arriving from the base station BS, extracts the latest UL/DL switching timing among the UL/DL switching timings, and stores the UL/DL switching timing in the memory 150 (step S1).

Next, the master station 100 detects the transmission delay time of each subordinate remote station 200 and stores the longest time in the memory 150 as remote station delay information (step S2). For example, the delay time to a remote device having a longest transmission path length between the local station and the remote device is generated as the remote station delay information. Next, the master station 100 communicates with the other master stations 100, and shares the UL/DL switching timing (timing information 150a), the remote station delay information 150b, and the weight 150c of the local station with the other (n−1 master stations 100 (step S3).

Next, the master station 100 generates the management table 150d based on the shared information (step S4). The management table 150d includes the UL/DL switching timing of each master station 100, a device ID of the set of the master stations (CA candidate device group) within the correction valid range, and a sum of the weights for each CA candidate device group.

Next, the master station 100 corrects the management table 150d such that the CA candidate device groups within the valid range in the other master stations 100 match (step S5). The processing in step S5 will be described in detail below.

When the correction of the management table 150d is completed, the master station 100 stops itself according to the corrected management table 150d or adjusts the UL/DL switching timing of the local station to be matched with the latest UL/DL switching timing in the CA candidate device group to which the local station belongs (step S6). That is, as a result of the correction of the management table 150d, the master station 100 whose own weight becomes 0 stops the downlink signal in the carrier band. The master station 100 whose weight is not 0 resets the UL/DL switching timing of the local station at the latest timing among the shared timings.

Then, the master station 100 adjusts the delay amount of the subordinate remote station to be matched with the latest remote station delay time in the CA candidate device group to which the local station belongs (step S7).

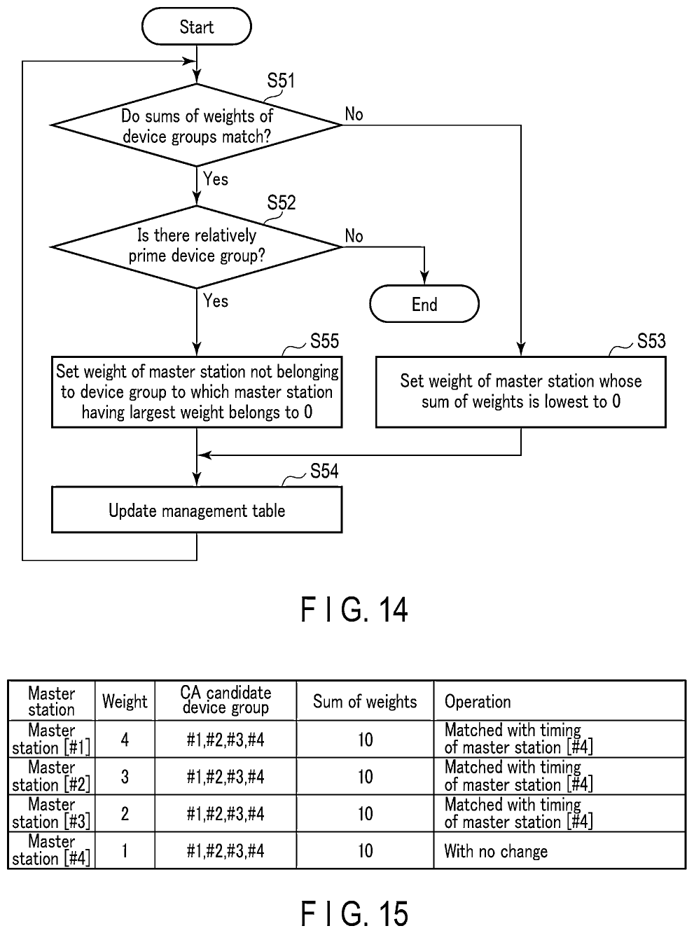

FIG. 14 is a flowchart illustrating an example of a processing procedure in step 5 in FIG. 11. Step 5 is a step of correcting the management table initially generated by information sharing between the master stations 100 by loop processing. A management table of FIG. 15 will also be described.

FIG. 15 is a diagram illustrating an example of information registered in the management table 150d. FIG. 15 illustrates the management table 150d generated in step S4 (FIG. 13) in the state of <Case 0> (FIG. 6). Here, it is assumed that the four master stations [#1] to [#4] are involved, but it is newly assumed that the weight of the master station [#1] is 4, the weight of the master station [#2] is 3, the weight of the master station [#3] is 2, and the weight of the master station [#4] is 1.

In FIG. 14, first, the master station 100 determines whether the sums of the weights of the plurality of CA candidate device groups match (step S51). As illustrated in FIG. 15, when the weights match (all the sums of the weights in FIG. 15 are 10), the master station 100 determines whether there is a CA candidate device group not having the same element (step S52). That is, the master station 100 determines the presence or absence of a relatively prime device group. The “relatively prime device group” is a “CA candidate device group not having the same element”, that is, it can be understood as a “CA candidate device group not having a common element”. When (No) in step S52, that is, when all the master stations as the elements of the CA candidate device groups are the same, the master station exits the processing, and the processing procedure proceeds to step S6 of FIG. 13.

On the other hand, when No in step S51, the master station 100 sets the weight of the master station having the lowest sum of weights to 0 (step S53), and then calculates the sum of weights again to update the management table 150d (step S54). The procedure of steps S53 and S54 is repeatedly looped until the sums of the weights of the device groups become the same in step S51.

When Yes in step S52, that is, when there is a CA candidate device group having the same sum of weights but different elements, the master station 100 sets the weight of the master station belonging to the device group that is not the device group to which the master station having the largest weight belongs (that is, the weight of the master station not belong to the device group to which the master station having the largest weight belongs) to 0 (step S55). Then, the master station 100 updates the management table 150d by calculating the sum of the weights again (step S54).

As illustrated in FIG. 15, in Case 0, the management table 150d is not changed even after step S5. Based on the management table 150d, each master station 100 matches the UL/DL switching timing of the local station with the device (master station [#4]) having the latest UL/DL switching timing in the CA candidate device group.

Next, the above processing procedure will be described for each of <Case 1> and <Case 2>. <Case 1>

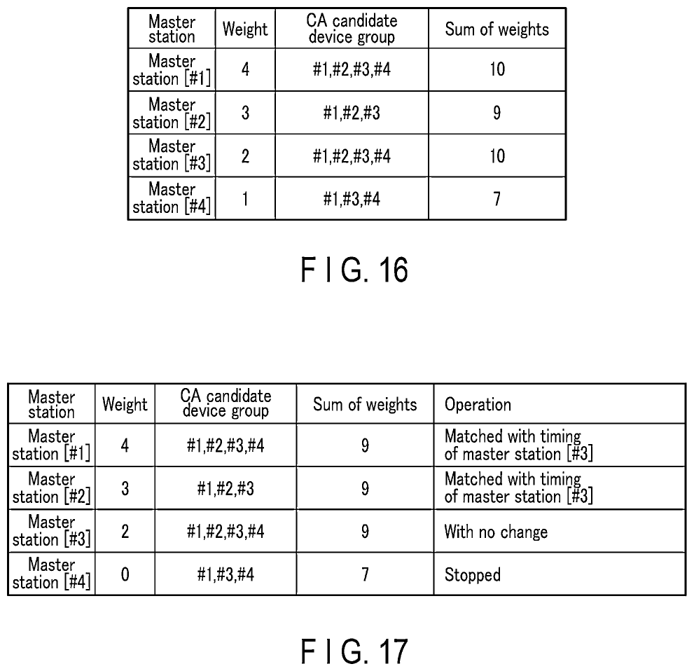

FIG. 16 illustrates the management table 150d generated in step S4 (FIG. 13) in the state of <Case 1> (FIG. 7). In this case, the sum of the weights of the CA candidate device group to which the master station [#4] belongs is 7, which is the lowest. Therefore, the management table 150d is updated as illustrated in FIG. 17 with the weight of the master station [#4] set to 0 (zero). In FIG. 17, the weights of the CA candidate device groups of the master station [#1], the master station [#2], and the master station [#3] become 9, and the processing procedure of FIG. 14 exits from the loop here. In FIG. 17, since the elements of the CA candidate device group whose sum of weights is not 0 match, this state becomes the final management table 150d.

Then, according to the management table 150d, the master stations [#1] to [#3] are matched with the UL/DL switching timing of the master station [#3], and the master station [#4] is stopped. Finally, the master stations [#1] to [#3] adjust the delay amounts of the subordinate remote stations.

In FIG. 8, the master station [#1] and the master station [#3] have the timing of the master station [#4], and the master station [#2] has the timing of the master station [#3], and a mismatch has occurred. Therefore, carrier aggregation cannot be performed without any change. To cope with the situation, by executing the processing procedures of FIGS. 13 and 14, it is possible to match all the timings of the master stations 100 that are not stopped as illustrated in FIG. 17. That is, it is possible to solve the problem in <Case 1> and perform carrier aggregation without any problem.

### <Case 2>

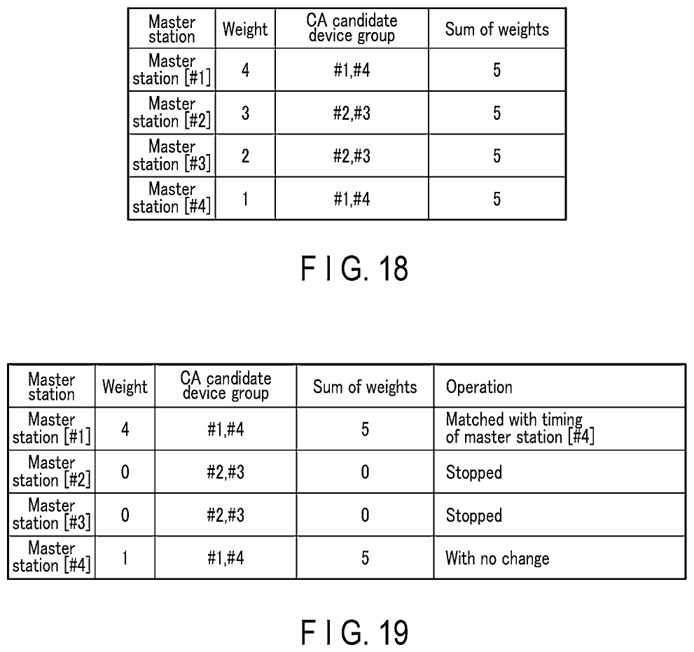

FIG. 18 illustrates the management table 150d generated in step S4 (FIG. 13) in the state of <Case 1> (FIG. 7). In this case, all the sums of the weights of the CA candidate device groups to which the master stations [#1] to [#4] belong are 5. However, different CA candidate device groups exist. That is, there is a set of master stations having the same sum of weights and being relatively prime.

Therefore, in step S55 (FIG. 14), among the different CA candidate device groups, the weights of the master stations [#2] and [#3] not belonging to the CA candidate device groups (#1 and #4) to which the master station [#1] having the largest weight belongs are set to 0, and the management table 150d is updated. Then, the management table 150d is updated as illustrated in FIG. 19 and reaches the final state.

Then, according to the management table 150d, the master stations [#2] and [#3] are stopped, and the master stations [#1] and [#4] are matched with the UL/DL switching timing of the master station [#4]. Finally, the master stations [#1] and [#4] adjust the delay amounts of the subordinate remote stations.

In FIG. 10, all the master stations [#1] to [#4] have been blindly stopped. To cope with the situation, by executing the processing procedures of FIGS. 13 and 14, it is possible to prevent originally unnecessary stop, and it is possible to match all the timings of the master stations 100 that are not stopped as illustrated in FIG. 19. That is, it is possible to solve the problem in <Case 2> and perform carrier aggregation without any problem.

As described above, according to the embodiment, the weight is set in advance for each base station, and the concept of the CA candidate device group, which is a set of master stations within the valid correction range, is introduced. Moreover, the timing on the base station side in the carrier band and the delay amount on the remote station side are detected by each master station 100, and the master stations 100 communicate with each other to share the information. Then, the sum of the weights of the master stations of the elements is calculated for each CA candidate device group, and master station autonomously determines the UL/DL switching timing to be synchronized and whether the local station is to be stopped based on a priority corresponding to the weight.

In the existing techniques, in a case where the optical repeater is connected to the base station, the UL/DL switching timing difference between the carriers cannot be kept within the 3GPP rule, and as a result, there is a possibility that the effect of CA cannot be obtained. In addition, in executing CA, a concern that a mismatch occurs between the carriers cannot be eliminated, and there is a problem in operation.

To cope with the concern and problem, according to the embodiment, it is possible to reliably prevent the mismatch of the UL/DL switching timings between the carrier bands, and it is possible to minimize the number of the carrier bands and the master station 100 leading to the stop. Therefore, according to the embodiment, it is possible to perform operation that enables CA among the plurality of optical repeater devices. That is, according to the embodiment, it is possible to provide an optical repeater system, an optical repeater device, a master unit, and a synchronization control method for enabling execution of carrier aggregation involving different optical repeater devices, thereby further improving availability.

Note that the present invention is not limited to the above-described embodiment as it is. For example, the weighting criterion for the master station is not limited to the number of accommodated remote stations and the carrier band, and can be freely set according to, for example, an operation policy of the communication service provider to which the UE belongs. For example, for the service provider who places importance on the band in the uplink, the weight may be set by a method such as combination optimization so as to maximize an opportunity of carrier aggregation in the uplink.

The embodiments of the present invention are presented by way of examples and are not intended to limit the scope of the invention. The new embodiments can be implemented in various other forms, and various omissions, replacements, and modifications can be made without departing from the gist of the invention. The embodiments and modifications thereof are included in the scope and gist of the invention, as well as within the scope of the invention described in the claims and their equivalents.

1. An optical repeater system comprising: a plurality of master units connectable to a base station to which a carrier band to be subjected to carrier aggregation is assigned and a remote unit including an antenna capable of transmitting uplink/downlink (UL/DL) signal of the carrier band, wherein
each of the master units includes:
a memory stores a weight assigned to the each master unit in advance;
a timing detector detects a UL/DL switching timing for each carrier band of a subordinate base station;
an information sharer communicates with another master unit and shares information including at least the weight and a latest UL/DL switching timing among the detected UL/DL switching timings with the another master unit;
a determinator autonomously determines the own UL/DL switching timing based on the shared information; and
a synchronization controller sets the own UL/DL switching timing to the determined UL/DL switching timing.

2. The optical repeater system according to claim 1, wherein
the determinator
calculates, for each set including master units as elements in which the shared UL/DL switching timing falls within a prescribed range, a sum of the weights assigned to the master units as elements; and
determines the own UL/DL switching timing based on the sum of the weights.

3. The optical repeater system according to claim 2, wherein
the determinator
determines stop of a downlink signal of a master unit not belonging to a set to which a master unit having a largest weight belongs, among sets having the same sum of weights and being relatively prime, and
the synchronization controller stops the downlink signal in the carrier band in a case where the stop of the own downlink signal is determined.

4. The optical repeater system according to claim 1, wherein the weight assigned to the each master unit is the number of connected remote units in the master unit.

5. The optical repeater system according to claim 1, wherein the weight assigned to the each master unit corresponds to the carrier band assigned to the base station connected to the each master unit.

6. The optical repeater system according to claim 1, wherein
the master unit further includes:
a delay detector detects a transmission delay time of each subordinate remote unit,
the information sharer further shares the transmission delay time with the another master unit, and
the synchronization controller sets the UL/DL switching timing of the subordinate remote unit based on the shared transmission delay time.

7. The optical repeater system according to claim 2, wherein
the master unit further includes:
a delay detector detects a transmission delay time of each subordinate remote unit,
the information sharer further shares the transmission delay time with the another master unit, and
the synchronization controller sets the UL/DL switching timing of the subordinate remote unit based on the shared transmission delay time.

8. The optical repeater system according to claim 3, wherein
the master unit further includes:
a delay detector detects a transmission delay time of each subordinate remote unit,
the information sharer further shares the transmission delay time with the another master unit, and
the synchronization controller sets the UL/DL switching timing of the subordinate remote unit based on the shared transmission delay time.

9. The optical repeater system according to claim 4, wherein
the master unit further includes:
a delay detector detects a transmission delay time of each subordinate remote unit,
the information sharer further shares the transmission delay time with the another master unit, and
the synchronization controller sets the UL/DL switching timing of the subordinate remote unit based on the shared transmission delay time.

10. The optical repeater system according to claim 5, wherein
the master unit further includes:
a delay detector detects a transmission delay time of each subordinate remote unit,
the information sharer further shares the transmission delay time with the another master unit, and
the synchronization controller sets the UL/DL switching timing of the subordinate remote unit based on the shared transmission delay time.

11. An optical repeater device comprising:
a base station connection unit connectable to a base station to which a carrier band to be subjected to carrier aggregation is assigned;
a remote unit including an antenna capable of transmitting and receiving an uplink/downlink (UL/DL) signal of the carrier band;
a memory stores a weight assigned to the optical repeater device in advance;
a timing detector detects a UL/DL switching timing for each carrier band of a subordinate base station;
an information sharer communicates with another master unit and shares information including at least the weight and a latest UL/DL switching timing among the detected UL/DL switching timings with the another master unit;
a determinator autonomously determine the own UL/DL switching timing based on the shared information; and
a synchronization controller sets the own UL/DL switching timing to the determined UL/DL switching timing.

12. A synchronization control method of an optical repeater system including a plurality of master units connectable to a base station to which a carrier band to be subjected to carrier aggregation is assigned and a remote unit including an antenna capable of transmitting and receiving an uplink/downlink (UL/DL) signal of the carrier band, the synchronization control method comprising:
a process in which the master unit detects a UL/DL switching timing for each carrier band of a subordinate base station;
a process in which the master unit communicates with another master unit and shares information including at least the weight assigned to the master unit in advance and a latest UL/DL switching timing among the detected UL/DL switching timings with the another master unit;
a process in which the master unit autonomously determines the own UL/DL switching timing based on the shared information; and
a process in which the master unit sets the own UL/DL switching timing to the determined UL/DL switching timing.
